(19) United States
(12) Patent Application Publication
(10) Pub. No.: US 2025/0196161 A1
(43) Pub. Date: Jun. 19, 2025

(54) ELECTRODE PLATE, AND PURIFICATION AND DUST REMOVAL DEVICE

(71) Applicant: AirQuality Technology (Shanghai) Co., Ltd., Shanghai (CN)

(72) Inventors: Shanqing MENG, Shanghai (CN); Lisun WANG, Shanghai (CN); Shidan LONG, Shanghai (CN)

(21) Appl. No.: 19/012,789

(22) Filed: Jan. 7, 2025

Related U.S. Application Data
(63) Continuation of application No. PCT/CN2024/132608, filed on Nov. 18, 2024.

(30) Foreign Application Priority Data
Dec. 14, 2023 (CN) 2023117309079

(51) Int. Cl. B03C 3/47; B03C 3/08; B03C 3/62; B03C 3/64; B03C 3/70; B03C 3/86

(52) U.S. Cl. CPC B03C 3/47; B03C 3/08; B03C 3/62; B03C 3/64; B03C 3/70; B03C 3/86

(57) ABSTRACT

The present invention relates to an electrode plate, and a purification and dust removal device, and belongs to the technical field of air purification. The electrode plate includes a body, the body includes a conductive layer located inside a semiconductor layer, an edge of the body is provided with a plurality of fixed mounting positions and a plurality of avoiding ports in a length direction thereof, the body further includes an insulation layer, the semiconductor layer is arranged on two sides of the insulation layer, and the conductive layer is located inside the semiconductor layer. According to the present invention, the technical problem in the prior art that a dust thin layer formed on a dust collection surface generates a back corona phenomenon, thereby repelling the capture of particulate matters and affecting the purification efficiency of the purification and dust removal device can be solved.

### CROSS-REFERENCE TO RELATED APPLICATIONS

The present application claims priority to Chinese Patent Application No. 2023117309079, filed on Dec. 14, 2023, the entire disclosure of which is incorporated herein by reference.

### TECHNICAL FIELD

The present invention belongs to the technical field of air purification, and in particular to an electrode plate, and a purification and dust removal device.

### BACKGROUND

Currently, the mainstream technologies for air purification are divided into a filtration technology and an electrostatic technology. The filtration technology filters or adsorbs pollutants in the air through fibers and fiber-based filtering materials, thereby purifying the air. The technology is mature and relatively stable in operation. However, the labor cost, material cost, operation cost and maintenance cost are very high, and improper maintenance may pose certain safety risks. Due to the continuous interception of pollutants in the air by filter materials, the gaps between fibers are constantly blocked, and wind resistance is increasing. Therefore, frequent cleaning and replacement of filter materials are required. At the same time, bacteria and viruses in the air trapped in filter materials can cause the problems such as bacterial growth, mold growth, and odor. The electrostatic technology charges particulate matters in gas through ionization modules, and the charged particulate matters are adsorbed by the electric field formed by a dust collection module to complete purification.

Various high-voltage electrostatic dust removal devices developed and designed using the principles of electrostatic technology can purify wide flow rate and complete particle pollution. The high-voltage electrostatic dust removal devices can achieve relatively stable use in environments such as different temperatures and humidities, and can be well applied to air filtration treatment in household, commercial, industrial, tunnel, subway and other fields. The high-voltage electrostatic dust removal devices have the technical characteristics of long service life, high purification efficiency, low operating costs, and low maintenance costs.

A purification device made of dust collection plates with conductive materials wrapped by insulating materials can have the distance between the dust collection plates set very close. In this way, the surface area of the dust collection plates for collecting dust can be made very large, enabling the capture of more particulate matter and other pollutants. The dust collection module formed by encapsulating conductive materials with insulating materials forms a thin layer of dust on the dust collection surface as the accumulation of particulate matter increases in the later stage of operation. The dust thin layer generates a back corona phenomenon, which forms a charge accumulation on the surface of the dust thin layer with the same charge as the particulate matter, thereby repelling the capture of particulate matter and affecting the purification efficiency of the dust collection module. Currently, there is a lack of a novel dust collection module structure form that can quickly transfer and capture the charges of the particulate matters, resulting in better efficiency and longer maintenance cycle of the dust collection module.

### SUMMARY

In view of the various shortcomings of existing technologies, an electrode plate and a purification and dust removal device are proposed to solve the technical problem of back corona phenomenon caused by the formation of a dust thin layer on a dust collection surface in the existing technology, thereby repelling the capture of particulate matters and affecting the purification efficiency of the purification and dust removal device.

To achieve the foregoing objective, the present invention provides the following technical solutions:
according to a first aspect, the present invention provides an electrode plate, including a body, the body includes a conductive layer located inside a semiconductor layer, and an edge of the body is provided with a plurality of fixed mounting positions and a plurality of avoiding ports in a length direction thereof; and
the body further includes an insulation layer, the semiconductor layer is arranged on two sides of the insulation layer, and the conductive layer is located inside the semiconductor layer.

The technical solution is further provided such that an end portion of the body serves as a power connection end, and the power connection end is provided with a necked receiving power connection port.

The technical solution is further provided such that the length of the conductive layer is less than that of the semiconductor layer, and the conductive layer extends to the power connection end.

The technical solution is further provided such that the area of one end portion of the conductive layer located at the power connection end is less than the area of the other end portion of the conductive layer.

The technical solution is further provided such that the end portion of the body is provided with a process circular hole, and a spacing between the process circular hole and the end portion of the body is 2-5 mm.

The technical solution is further provided such that the fixed mounting positions and the avoiding ports are set as slotted openings and/or semicircular openings, respectively.

The technical solution is further provided such that grooves facing the avoiding ports are formed inside the fixed mounting positions.

The technical solution is further provided such that the spacings between an edge of the conductive layer, the fixed mounting positions and the avoiding ports are equal.

The technical solution is further provided such that the conductive layer is made of a conductive material and an additive, the conductive material including graphite, graphene or conductive printing ink, and the additive including organosilicon; the semiconductor layer is made of a high polymer material and a heat conduction material, the high polymer material including polyvinyl chloride, polyethylene, polypropylene, ABS plastic or polytetrafluoroethylene, and the heat conduction material including one or more combinations of aluminium oxide, silicon dioxide, metal powder, silicon nitride, aluminium nitride, zinc oxide, calcium oxide, graphite and graphene; and the insulation layer is made of one or more combinations of polypropylene, ABS plastic, polyamide, polyoxymethylene, polytetrafluoroethylene or polycarbonate.

The technical solution is further provided such that the thickness of the insulation layer is 0.1-1.0 mm, the thickness of the semiconductor layer is 0.05-0.5 mm, and the thickness of the conductive layer is 0.005-0.03 mm.

The technical solution is further provided such that adhesive layers are provided between the semiconductor layer, and the insulation layer and the conductive layer.

According to a second aspect, the present invention provides a purification and dust removal device, including a frame body, where a plurality of alternately superimposed ground electrode plates and high-voltage electrode plates are provided inside the frame body, and the ground electrode plates and the high-voltage electrode plates employ the electrode plate.

The technical solution is further provided such that the ground electrode plates and the high-voltage electrode plates are connected to fixed separators, respectively, and the fixed separators are insulation adhesives and/or rigid insulating parts.

The technical solution is further provided such that an insulation adhesive layer is provided between the ends of the frame body and the electrode plate, and the insulation adhesive layer covers the process circular hole at the end portion of the electrode plate.

The technical solution is further provided such that the ground electrode plates and the high-voltage electrode plates are provided in a 180° staggered manner, gaps are present between end portions of the ground electrode plates and the high-voltage electrode plates, and the insulation adhesive layer does not cover or cover the gaps.

The technical solution is further provided such that the thickness of the semiconductor layer of the dust collection layer electrode plate is less than that of the non-dust collection layer electrode plate.

The technical solution is further provided such that the purification and dust removal device further includes a high-voltage power supply, where the high-voltage power supply is located inside or outside the frame body.

The present invention has the following beneficial effects:

1. By adding an insulation layer in the middle of the electrode plate, the strength and stability of the electrode plate can be improved. The semiconductor layer on the dust collecting surface of the electrode plate not only has the insulation properties of the insulation material, but also considers the conductivity of the conductive material. This can ensure electrical safety while quickly transferring the charges of the captured particulate matters, reducing the occurrence of the back corona, increasing the dust capacity, and extending the maintenance cycle.

2. By designing the avoiding ports, the connection of ground electrode plates and high-voltage electrode plates with the fixed separators can be staggered, avoiding the formation of leakage current between the ground electrode plates and the high-voltage electrode plates, which affects the capture of particulate matter, while maintaining the stability of the purification and dust removal device structure and extending the maintenance cycle.

3. The use of the electrode plates with this structure to manufacture the purification and dust removal device not only can improve the stability of the purification and dust removal device and ensure the normal use, but also can effectively reduce the spacing between electrode plates and increase the dust collection area to capture more pollutants, improve the purification efficiency and increase the dust holding capacity.

### BRIEF DESCRIPTION OF THE DRAWINGS

FIG. 1 is a top view of an electrode plate according to an embodiment of the present invention;

FIG. 2 is a side view of an electrode plate according to embodiment of the present invention;

FIG. 3 is a top view of another implementation of an electrode plate according to an embodiment of the present invention;

FIG. 4 is a top view of another implementation of an electrode plate according to an embodiment of the present invention;

FIG. 5 is a top view of another implementation of an electrode plate according to an embodiment of the present invention;

FIG. 6 is a top view of another implementation of an electrode plate according to an embodiment of the present invention;

FIG. 7 is a top view of another implementation of an electrode plate according to an embodiment of the present invention;

FIG. 8 is a top view of another implementation of an electrode plate according to an embodiment of the present invention;

FIG. 9 is a top view of another implementation of an electrode plate according to an embodiment of the present invention;

FIG. 10 is a top view of another implementation of an electrode plate according to an embodiment of the present invention;

FIG. 11 is a top view of another implementation of an electrode plate according to an embodiment of the present invention;

FIG. 12 is a schematic diagram of a purification and dust removal device according to an embodiment of the present invention;

FIG. 13 is an exploded view of a purification and dust removal device according to an embodiment of the present invention; and

FIG. 14 is a partial schematic diagram of a position A in FIG. 13.

### DETAILED DESCRIPTION OF THE EMBODIMENTS

To make those skilled in the art better understand the technical solutions of the present invention, the technical solutions of the present invention are clearly and completely described below with reference to the accompanying drawings of the present invention. Other embodiments obtained by a person of ordinary skill in the art based on the embodiments of the present application without creative efforts shall fall within the protection scope of the present application. In addition, the directional terms mentioned in the following embodiments, such as “up”, “down”, “left”, “right”, etc., are merely referring to the directions in the accompanying drawings. Therefore, the used directional terms are intended to illustrate rather than limit the present invention.

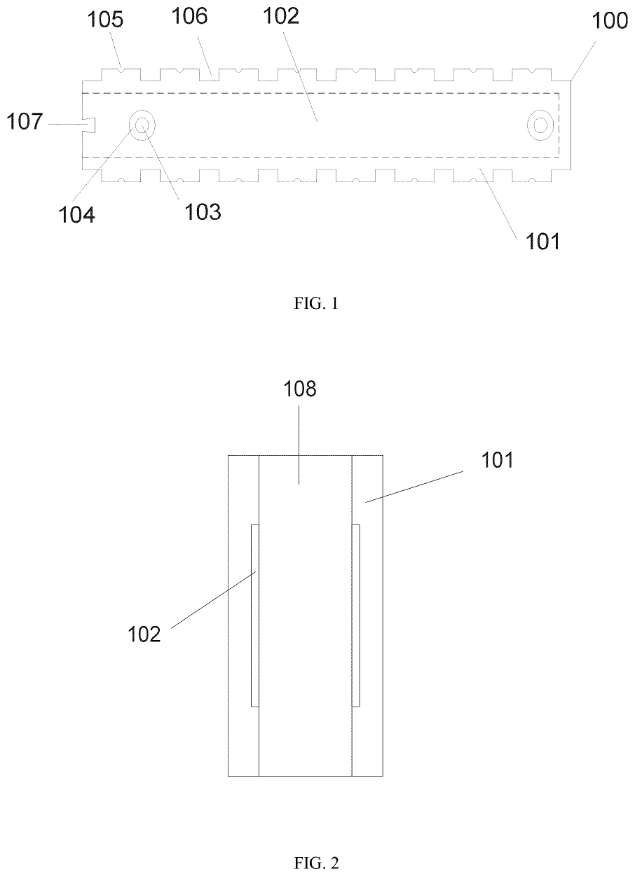

According to an embodiment of the present invention, an electrode plate is provided, referring to FIG. 1 and FIG. 2, including a body 100, where the body 100 includes a conductive layer 101 located inside a semiconductor layer 102, and an edge of the body 100 is provided with a plurality of fixed mounting positions 105 and a plurality of avoiding ports 106 in a length direction thereof; and
the body 100 further includes an insulation layer 108, the semiconductor layer 101 is arranged on two sides of the insulation layer 108, and the conductive layer 102 is located inside the semiconductor layer 101.

It should be noted that by adding an insulation layer in the middle of the electrode plate, the strength and stability of the electrode plate can be improved. The semiconductor layer on the dust collecting surface of the electrode plate not only has the insulation properties of the insulation material, but also considers the conductivity of the conductive material. This can ensure electrical safety while quickly transferring the charges of the captured particulate matters, reducing the occurrence of the back corona, increasing the dust capacity, and extending the maintenance cycle. By designing the avoiding ports, the connection of ground electrode plates and high-voltage electrode plates with the fixed separators can be staggered, avoiding the formation of leakage current between the ground electrode plates and the high-voltage electrode plates, which affects the capture of particulate matter, while maintaining the stability of the purification and dust removal device structure and extending the maintenance cycle. The use of the electrode plates with this structure to manufacture the purification and dust removal device not only can improve the stability of the purification and dust removal device and ensure the normal use, but also can effectively reduce the spacing between electrode plates and increase the dust collection area to capture more pollutants, improve the purification efficiency and increase the dust holding capacity.

Specifically, the conductive layer 102 is set as a long strip shape, which may be provided with one or more strips.

In the electrode plate of this embodiment, referring to FIG. 1, an end portion of the body 100 serves as a power connection end, and the power connection end is provided with a necked receiving power connection port 107.

It should be noted that a metal wire/rod is inserted into the necked receiving power connection port 107 to achieve power connection, and the necked receiving power connection port 107 exerts an inward force on the metal wire/rod, resulting in a higher fitness between the metal wire/rod and the conductive layer 102.

Referring to FIG. 1, the necked receiving power connection port 107 includes an opening end and a closed end, a protruding end is arranged between the opening end and closed end, and the metal wire/rod enters the power connection port 107 from the opening end. The cross-section of the necked receiving power connection port 107 is an isosceles trapezoid, the upper bottom of the isosceles trapezoid serving as the opening end, the lower bottom of the isosceles trapezoid serving as the closed end, and the lateral sides of the isosceles trapezoid serving as the protruding end. By using the protruding end to exert an inward force on metal wire/rod, the power connection port 107 is clamped with the metal wire/rod.

Preferably, an included angle between the protruding end and the horizontal direction is 10-25°. When the included angle is less than 10°, the power connection port 107 is more prone to be clamped with the metal wire/rod, with poor firmness after clamping. When the included angle is greater than 25°, the power connection port 107 is more difficult to be clamped with the metal wire/rod, with better firmness after clamping. When the included angle is equal to 15°, the power connection port 107 is more prone to be clamped with the metal wire/rod, with better firmness after clamping.

In addition, an arc matched with the metal wire/rod can be arranged at the protruding end, such that the metal wire/rod partially falls into the arc after being clamped into the power connection port 107, making the clamping tighter.

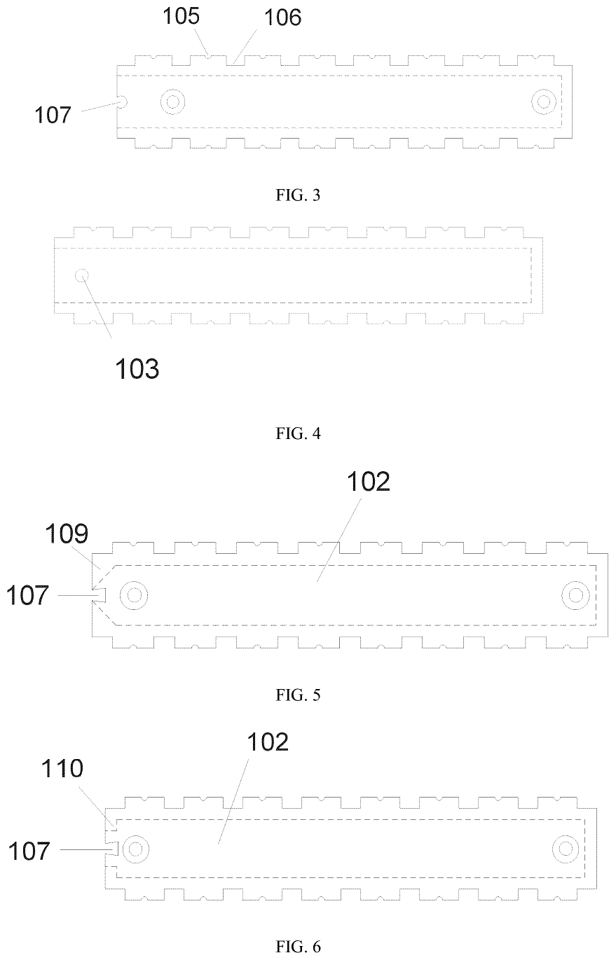

Referring to FIG. 3, the cross-section of the necked receiving power connection port 107 is circular arc-shaped, and the contact area between the circular arc and metal wire/rod increases, resulting in better power connection stability. Preferably, the circular arc is a major arc. The diameter of the metal wire/rod is matched with the circular arc, with a gap of 0.2-1 mm. When the gap is less than 0.2 mm, the gap between the metal wire/rod and the circular arc is too small to clamp easily, and the requirement of the manufacturing process is too high. When the gap is greater than 1 mm, the gap between the metal wire/rod and the circular arc is excessive, resulting in loosing after clamping and poor power connection stability.

In the electrode plate of this embodiment, referring to FIG. 1, the length of the conductive layer 102 is less than that of the semiconductor layer 101, and the conductive layer 102 extends to the power connection end.

It should be noted that one end portion of the conductive layer 102 is flush with the end portion of the semiconductor layer 101 to achieve the stable power connection, while the other end of conductive layer 102 is not flush with the end portion of the semiconductor layer 101.

In the electrode plate of this embodiment, the area of one end portion of the conductive layer 102 located at the power connection end is less than the area of the other end portion of the conductive layer 102 to improve the electrical safety. During assembling, a plurality of electrode plates is butted in the frame body to form a purification and dust removal device. At the same time, insulating treatment is performed between the end portion of the body 100 and the frame body, and the end area of the conductive layer 102 located at the power connection end is reduced, which can prevent the electrical safety distance between the end portion of the conductive layer 102 and the frame body from being too close and avoid the influence on the stable operation in the later stage.

Referring to FIG. 5, an end portion of the conductive layer 102 located at the power connection end is inclined towards a direction away from the power connection end from an entrance of the power connection port 107, a first electrical safety area 109 is present between the power connection end and the conductive layer 102, two first electrical safety areas 109 are symmetrically provided and the first electrical safety area 109 is triangular, and the symmetrical structural design can maintain the uniformity of the electrical safety distance.

Referring to FIG. 6, the end portion of the conductive layer 102 located at the power connection end is provided with a notch, the notch forms second electrical safety areas 110, two second electrical safety areas 110 are symmetrically provided, and the second electrical safety areas 110 are square. The design of the symmetrical structures can maintain the homogeneity of the electrical safety distance. Specifically, the conductive layer 102 extends to an area between the notch and the power connection port 107.

In the electrode plate of this embodiment, referring to FIG. 1 and FIG. 4, the end portion of the body 100 is provided with a process circular hole 103, and the spacing between the process circular hole 103 and the end portion of the body 100 is 2-5 mm. At this point. At this time, the process circular hole 103 doubles as the power connection port 107.

It should be noted that the process circular hole 103 is moved towards the end portion of the body 100. During assembling, a plurality of electrode plates are butted in the frame body to form a purification and dust removal device. At the same time, insulating treatment is performed between the end portion of the body 100 and the frame body. insulation adhesive can cover the process circular hole 103, thereby solving the dead zone of purification generated near the process circular hole 103.

Referring to FIG. 1, the process circular hole 103 is further away from the body 100. After assembling, the process circular hole 103 is in a bare state. At this point, an insulating gap 104 is provided between the process circular hole 103 and the conductive layer 102 to form a safety distance.

In the electrode plate of this embodiment, referring to FIG. 1, the fixed mounting positions 105 and the avoiding ports 106 are set as slotted openings and/or semicircular openings, respectively.

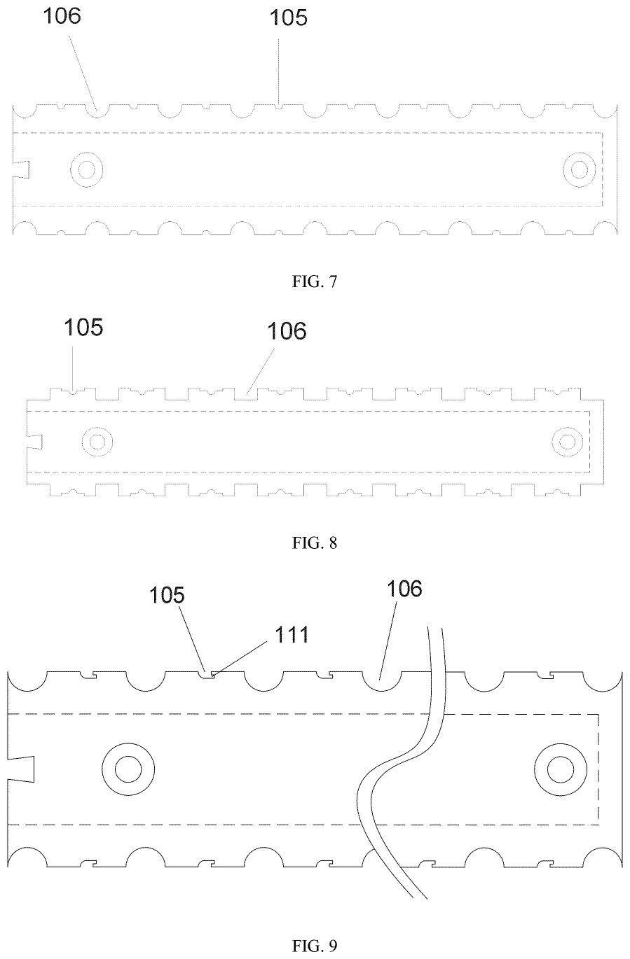

Specifically, referring to FIG. 1, the fixed mounting positions 105 are set as shallow arc openings, and the avoiding ports 106 are set as slotted openings. Referring to FIG. 7, the fixed mounting positions 105 are shallow arc openings, and the avoiding ports 106 are set as semicircular openings. In addition, the fixed mounting positions 105 and the avoiding ports 106 may also be set as slotted openings. Referring to FIG. 8, the fixed mounting positions 105 and the avoiding ports 106 are set as slotted openings. At the same time, the bottoms of the fixed mounting positions 105 are further provided with deepening ports of the semicircular openings.

In the electrode plate of this embodiment, referring to FIG. 1 and FIG. 9, grooves 111 facing the avoiding ports 106 are formed inside the fixed mounting positions 105.

It should be noted that the grooves 111 have increased the contact area between the fixed mounting positions 105 and the adhesive body, which can achieve vertical gluing of the purification and dust removal module. Vertical gluing can be carried out on both sides simultaneously, resulting in a higher production speed; and the design of the grooves 111 allows more adhesive bodies to penetrate into the grooves 111 during vertical gluing, forming a bonding between the adhesive body and the electrode plate in the grooves 111, with a larger contact area and better firmness.

In the electrode plate of this embodiment, referring to FIG. 11, the spacings between the edge of the conductive layer 102, the fixed mounting positions 105 and the avoiding ports 106 are equal.

It should be noted that according to the shapes of the fixed mounting positions 105 and the avoiding ports 106, the edge shape of the conductive layer 102 is designed to make full use of the effective area of the body 100, to maximize the proportion of the conductive layer 102 and not to affect electrical safety simultaneously. This helps to improve the area of the purification and dust removal device (or electrode plate) that captures particulate matter, prolong the action time on particulate matters, improve the purification efficiency of the particulate matters and correspondingly increase the dust holding capacity of the purification and dust removal device.

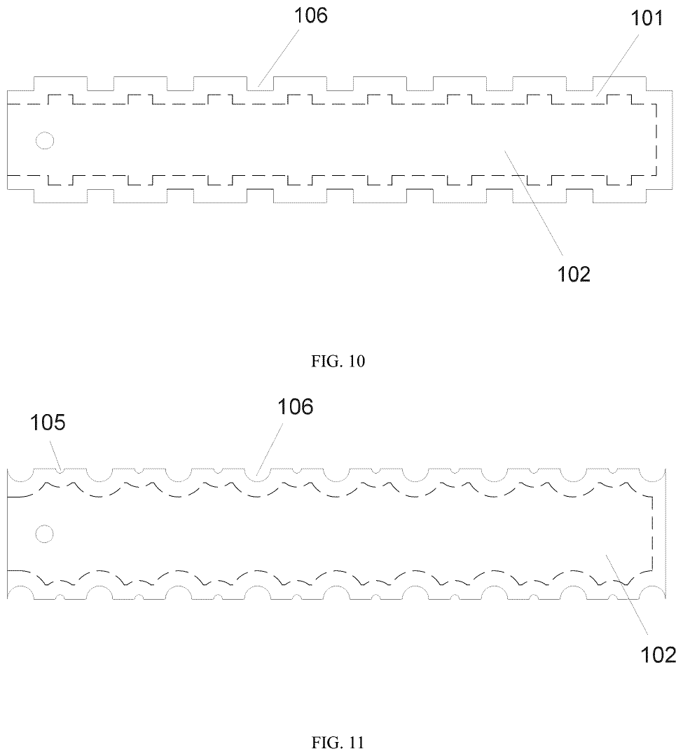

Referring to FIG. 11, the fixed mounting positions 105 and the avoiding ports 106 are semicircular openings, and thus, the edge of the conductive layer 102 resembles a wave. Referring to FIG. 10, the avoiding ports 106 are slotted openings, and thus, the edge of the conductive layer 102 resembles rectangular teeth.

In order to verify whether different shapes of conductive layers have an impact on the purification efficiency of the purification and dust removal device, the inventors conducted the following experiments. The PM2.5 purification efficiency of the purification and dust removal device with a length of 500 mm, a width of 400 mm, and a thickness of 50.8 mm are compared, under the same ionization device and ionization voltage at the front end, and in the same environment at two different air velocities. The experimental data are shown in Table 1.

TABLE 1

| | | Size of the | | | | |
|---|---|---|---|---|---|---|
| | | Purification | | | | |
| | Shape | and Dust | Gap of the | | Surface | PM2.5 |
| | of the | Removal | Electrode | Air | Air | Purification |
| Experimental | Electrode | Device | Plate | volume | Velocity | Efficiency |
| Scheme | Plate | mm | mm | m³/h | m/s | % |
| 1 | Waveform | 500*400*50.8 | 1.5 | 2160 | 3 | 98 |
| | Square | 500*400*50.8 | 1.5 | 2160 | 3 | 97 |
| | Common | 500*400*50.8 | 1.5 | 2160 | 3 | 93 |
| 2 | Waveform | 500*400*50.8 | 1.5 | 2880 | 4 | 96 |
| | Square | 500*400*50.8 | 1.5 | 2880 | 4 | 93 |
| | Common | 500*400*50.8 | 1.5 | 2880 | 4 | 86 |

From Table 1, it can be concluded that: the conductive layer 102 of the waveform (referring to FIG. 11) has the maximum proportion, and the PM2.5 purification efficiency is maximum at two different air velocities; the proportion of the conductive layer 102 in the square shape (referring to FIG. 10) is second only to the waveform, and the PM2.5 purification efficiency is also relatively high; and when the high air velocity is 4 m/s, the proportion of the ordinary (referring to FIG. 7) conductive layer 102 is the minimum, and the efficiency has the largest and most significant difference from waveforms and squares. Therefore, increasing the proportion of the conductive layer 102 is beneficial to ensuring PM2.5 purification efficiency of the purification and dust removal device, and the improvement in efficiency will also correspondingly increase the dust holding capacity of the purification and dust removal device.

In the electrode plate of this embodiment, referring to FIG. 1 and FIG. 2, the conductive layer 102 is made of a conductive material and an additive, the conductive material includes graphite, graphene or conductive printing ink, and the additive includes organosilicon, which can improve the heat resistance, water repellency, and corona resistance of the materials.

The semiconductor layer 101 is made of a high polymer material and a heat conduction material, the high polymer material includes polyvinyl chloride, polyethylene, polypropylene, ABS plastic or polytetrafluoroethyleneone, and the heat conduction material includes one or more combinations of aluminium oxide, silicon dioxide, metal powder, silicon nitride, aluminium nitride, zinc oxide, calcium oxide, graphite and graphene. To achieve wide applicability while balancing production processing and material costs, polyethylene (abbreviated as PE) is preferred. Polyethylene has excellent low-temperature resistance and can maintain good mechanical properties even at −60° C. PE is odorless, tasteless, non-toxic, with a matte, milky white, waxy appearance. PE has the melting point ranging from 100° C. to 130° C., and is insoluble in water. PE remains flexible at low temperatures and has high electrical insulation and relatively high thermal conductivity.

The insulation layer 108 is made of one or more combinations of polypropylene, ABS plastic, polyamide, polyoxymethylene, polytetrafluoroethylene or polycarbonate. The insulation layer 108 is made of a rigid material. By virtue of the insulativity and supportability of the insulation layer, the stiffness of the electrode plate is maintained. Polycarbonate is preferred, also known as PC plastic. The polycarbonate is colorless and transparent, heat-resistant, impact-resistant, has good mechanical properties, with a flame retardant grade BI, a melting point of 220° C. to 230° C., and possesses flame retardance and inoxidizability.

In the electrode plate of this embodiment, referring to FIG. 1 and FIG. 2, the thickness of the insulation layer 108 is 0.1-1.0 mm, preferably 0.3 mm. If the insulation layer 108 is too thin, for example, less than 0.1 mm, the supporting strength will be insufficient and the electrode plate is prone to deformation; if the insulation layer 108 is too thick, for example, greater than 1 mm, under the condition that the sizes of other layers are the same, the thickness of the electrode plate will be relatively thick, and the effective ventilation area per unit area of the corresponding purification and dust removal device will become smaller, and the purification efficiency and the dust holding capacity will be reduced. The range of 0.1-1 mm can balance the supportability and control of the thickness of the electrode plate. The thickness of the semiconductor layer 101 is 0.05-0.5 mm, preferably 0.15 mm. If the semiconductor layer 101 is too thin, for example, less than 0.05 mm, it is difficult to process during production, and it is prone to damage during actual operation, affecting the stability; if the semiconductor layer 101 is too thick, for example, greater than 0.5 mm, under the condition that the sizes of other layers are the same, the thickness of the electrode plate will be relatively thick, the effective ventilation area per unit area of the corresponding purification and dust removal device will become smaller, and the purification efficiency and the dust holding capacity will be reduced. A range of 0.05-0.5 mm can balance conductivity and control of the thickness of the electrode plate. The thickness of the conductive layer 102 is 0.005-0.03 mm, preferably 0.01 mm.

Specifically, adhesive layers are provided between the semiconductor layer 101, and the insulation layer 108 as well as the conductive layer 102. The conductive layer 102, the insulation layer 108 and the semiconductor layer 101 are integrated into one by means of the adhesive layers.

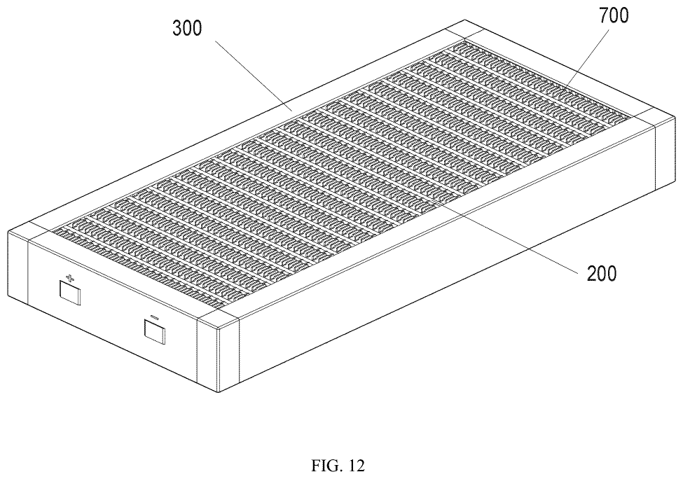

According to the embodiments of the present invention, a purification and dust removal device is provided, referring to FIG. 12, including a frame body 300, where a plurality of alternately superimposed ground electrode plates and high-voltage electrode plates are provided in the frame body 300, and the ground electrode plates and the high-voltage electrode plates employ the electrode plate 700.

In the purification and dust removal device of this embodiment, referring to FIG. 12, the ground electrode plates and the high-voltage electrode plates are connected to the fixed separators 200, respectively, and the fixed separators 200 are insulation adhesives and/or rigid insulating parts.

Specifically, the insulation adhesive has high bonding strength and can withstand high and low temperature impacts, such as the PUR adhesive available on the market. It is also possible to use hot melt adhesive for fixation. However, the purification and dust removal device fixed with hot melt adhesive has limited application fields. The purification and dust removal device cannot be used in environments with large temperature differences throughout the year or between morning and evening. The hot melt adhesive is prone to become soft when exposed to high temperature and embrittle when exposed to low temperature.

After pouring the insulation adhesive into the shallow arc opening for fixation, an approximately circular adhesive body is formed. The circular adhesive body forms an equidistant safety distance from the avoiding ports 106. Meanwhile, the size of the shallow arc opening is adapted to the adhesive quantity. The adhesive body is flush with the edge of the electrode plate or slightly lower than the edge of the electrode plate. That is, a part of the adhesive body is inside the shallow arc opening, and a part is combined with the electrode plate, maintaining the surface flatness and aesthetics. Or the fixed mounting positions 105 are semicircular openings, and the avoiding ports 106 are deep arc openings. After pouring the insulation adhesive into the semicircular opening for fixation, an approximately circular adhesive body is formed. The circular adhesive body forms an equidistant safe distance from the avoidance ports 106. Meanwhile, the size of the semicircular opening is adapted to the adhesive quantity. The adhesive body after gluing is flush with the edge of the electrode plate or slightly lower than the edge of the electrode plate. That is, a part of the adhesive body is inside the semicircular opening, and a part is combined with the electrode plate to form an approximately circular adhesive body, maintaining the surface flatness and aesthetics. The design of the equidistant safety distance mainly includes the aforementioned two forms. It takes advantage of the natural sedimentation of the insulation adhesive and the combinations of the insulation adhesive with the electrode plate to form an approximately circular adhesive body. The design of the equidistant safety distance can increase the proportion of the conductive layer of the electrode plate as much as possible, thereby improving the purification efficiency and dust holding capacity of the purification and dust removal device and prolonging the maintenance cycle. The design of the equidistant safety distance is such that in the later stage of the operation of the purification and dust removal device, a layer of dust will adhere to the adhesive body surface and the electrode plate surface. When encountering high humidity and other environments, the dust will have a certain conductivity, which will indirectly reduce the safety distance of the purification and dust removal device. At this point, the electrode plates and adhesive bodies connected to different potential voltages will generate leakage current due to the reduction of the electrical safety distance, thereby reducing the purification efficiency of the purification and dust removal device and shortening the maintenance cycle.

Specifically, at the contact point between the rigid insulating part and the electrode plate, the width of the rigid insulating part is increased in the length direction of the electrode plate. Meanwhile, the rigid insulating part is provided with an electrode plate slits to better clamp the electrode plate, increase the fixed contact area with the electrode plate, and promote the stability of the spacing between the electrode plates. In addition, the insulation adhesive can be combined with the rigid insulating part. One side of the electrode plate is fixed by the rigid insulating part, and the other side is fixed by the insulation adhesive. Furthermore, after the rigid insulating part clamps the electrode plate, the insulation adhesive is used for further fixation to increase the stability.

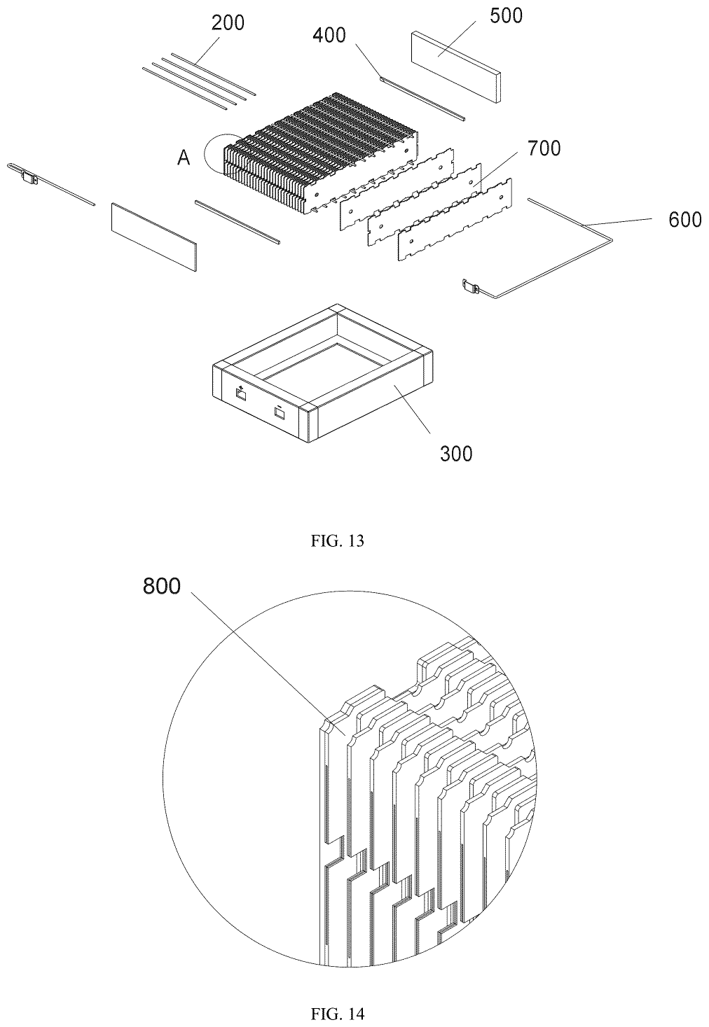

In the purification and dust removal device of this embodiment, referring to FIG. 1, FIG. 12 and FIG. 13, an electric conductor 400 and an insulation adhesive layer 500 are provided between the frame body 300 and the end of the electrode plate 700, and the insulation adhesive layer 500 covers the process circular hole 103 and the conductive port 107 at the end portion of the electrode plate.

Specifically, the electric conductor 400 is located at the end of the electrode plate 700. Meanwhile, the electric conductor 400 is embedded in the power connection port 107, and the insulation adhesive layer 500 is located between the electric conductor 400 and the frame body 300 and covers the process circular hole 103 and the conductive port 107. At the same time, the ground electrode plate and the high-voltage electrode plate are electrically connected to the frame body 300 through wires 600 respectively.

Specifically, referring to FIG. 14, the ground electrode plate and the high-voltage electrode plate are provided in a 180° staggered manner, and there is a gap 800 between the end portions of the ground electrode plate and the high-voltage electrode plate. The insulation adhesive layer does not cover the gap 800. In addition, the insulation adhesive layer can also cover the gap 800.

Specifically, the thickness of the semiconductor layer of the dust collection layer electrode plate is the same as that of the non-dust collection layer electrode plate, which is conducive to processing and production.

It should be noted that, the dust collection layers and non-dust collection layers of the electrode plates are related to the high voltage supplied by the purification and dust removal device as well as the high voltage supplied by the front end ionization device. Specifically, the electrical voltage should be well designed at the beginning and the high-voltage power supply should be properly matched. Correspondingly, the electrode plates can be matched during production. For example, if the ionization device is a direct-current positive high voltage, the particulate matter will carry a positive charge after passing through the ionization device. The electrode plates of the purification and dust removal device are stacked in an staggered manner. The electricity supplied to a part of the electrode plates is direct-current positive high voltage, and the other part of the electrode plates is connected to the ground electrode. For this purification and dust removal device, the electrode plates supplied with direct-current positive high voltage are the non-dust collection layer electrode plates, and the electrode plates connected to the ground are the dust collection layer electrode plates.

Specifically, the thickness of the semiconductor layer of the dust collection layer electrode plate is less than that of the non-dust collection layer electrode plate.

It should be noted that on the premise of satisfying electrical safety, the thickness of the semiconductor layer of the dust collection layer electrode plate is less than that of the non-dust collection layer electrode plate. In the initial stage of operation, the amount of the particulate matters accumulated on the dust collection surface is limited and has no impact on the purification efficiency. As the operation time increases, the accumulation of the particulate matters increases and the thickness of the dust layer increases. The thinned semiconductor layer can quickly conduct away the charges of the particulate matter, avoiding the formation of the back corona phenomenon, and ensuring the purification efficiency.

To verify whether different thicknesses of the semiconductor layer on the dust collection surface and the non-dust collection surface have an impact on the purification efficiency of the purification and dust removal device, the inventors conducted the following experiments. The change in PM2.5 purification efficiency of the purification and dust removal device with a length of 500 mm, a width of 300 mm, and a thickness of 50.8 mm are compared during long-term operation of the purification and dust removal device, under the same ionization device and ionization voltage at the front end, and in the same environment at two different air velocities. The experimental data are shown in Table 2.

TABLE 2

| | Purification and Dust Removal Device | | | | | | | |
|---|---|---|---|---|---|---|---|---|
| | | | | | | | | Size of the |
| | | | Thickness | Thickness | Thickness | Thickness | Thickness | Purification |
| | | | of the | of the | of the | of the | of the | and Dust |
| | | | Semiconductor | Conductive | Insulation | Conductive | Semiconductor | Removal |
| Experimental | | Electrode | Layer | Layer | Layer | Layer | Layer | Device |
| Scheme | No. | Plate | mm | mm | mm | mm | mm | mm |
| 1 | 1 | Dust | 0.2 | 0.02 | 0.2 | 0.02 | 0.2 | 500*300*50.8 |
| | | collection | | | | | | |
| | | layer | | | | | | |
| | | electrode | | | | | | |
| | | plate | | | | | | |
| | | Non-dust | 0.2 | 0.02 | 0.2 | 0.02 | 0.2 | |
| | | collection | | | | | | |
| | | layer | | | | | | |
| | | electrode | | | | | | |
| | | plate | | | | | | |
| | 2 | Dust | 0.15 | 0.02 | 0.3 | 0.02 | 0.15 | 500*300*50.8 |
| | | collection | | | | | | |
| | | layer | | | | | | |
| | | electrode | | | | | | |
| | | plate | | | | | | |
| | | Non-dust | 0.2 | 0.02 | 0.2 | 0.02 | 0.2 | |
| | | collection | | | | | | |
| | | layer | | | | | | |
| | | electrode | | | | | | |
| | | plate | | | | | | |
| 2 | 3 | Dust | 0.2 | 0.02 | 0.2 | 0.02 | 0.2 | 500*300*50.8 |
| | | collection | | | | | | |
| | | layer | | | | | | |
| | | electrode | | | | | | |
| | | plate | | | | | | |
| | | Non-dust | 0.2 | 0.02 | 0.2 | 0.02 | 0.2 | |
| | | collection | | | | | | |
| | | layer | | | | | | |
| | | electrode | | | | | | |
| | | plate | | | | | | |
| | 4 | Dust | 0.15 | 0.02 | 0.3 | 0.02 | 0.15 | 500*300*50.8 |
| | | collection | | | | | | |
| | | layer | | | | | | |
| | | electrode | | | | | | |
| | | plate | | | | | | |
| | | Non-dust | 0.2 | 0.02 | 0.2 | 0.02 | 0.2 | |
| | | collection | | | | | | |
| | | layer | | | | | | |
| | | electrode | | | | | | |
| | | plate | | | | | | |

| | Purification and Dust Removal Device | | | | | | |
|---|---|---|---|---|---|---|---|
| | Gap of | | | | Efficiency | Efficiency | Efficiency |
| | the | | Surface | | in 15 | in 30 | in 45 |
| | Electrode | Air | Air | Initial | days of | days of | days of |
| Experimental | Plate | Volume | Velocity | Efficiency | Operation | Operation | Operation |
| Scheme | mm | m³/h | m/s | % | % | % | % |
| 1 | 1.5 | 1080 | 2 | 99 | 95 | 90 | 85 |
| | 1.5 | 1080 | 2 | 99 | 96 | 93 | 89 |
| 2 | 1.5 | 540 | 1 | 99 | 97 | 93 | 87 |
| | 1.5 | 540 | 1 | 99 | 97 | 95 | 91 |

From Table 2, it can be intuitively concluded that: when the thickness of the semiconductor layer on the dust collection surface is less than that on the non-dust collection surface, the thinner semiconductor layer on the dust collection surface is more conducive to the rapid transfer of the charges of the captured particulate matter. The back corona phenomenon is less likely to form, which is more conducive to ensuring the purification efficiency of the purification and dust removal device and increasing the dust holding capacity.

The purification and dust removal device of this embodiment, referring to FIG. 1, FIG. 12 and FIG. 13, further includes a high-voltage power supply, where the high-voltage power supply is located inside or outside the frame body 300, that is, the high-voltage power supply may be arranged inside or outside.

The present invention has been described in detail above, and the above mentioned is only a preferred embodiment of the present invention and is not intended to limit the implementation scope of the present invention, i.e. all equivalent variations and modifications made within the claims of the present invention shall be included within the scope of the present invention.

What is claimed is:

1. An electrode plate, comprising a body, wherein the body comprises a conductive layer located inside a semiconductor layer, and an edge of the body is provided with a plurality of fixed mounting positions and a plurality of avoiding ports in a length direction thereof; and
the body further comprises an insulation layer, the semiconductor layer is arranged on two sides of the insulation layer, and the conductive layer is located inside the semiconductor layer.

2. The electrode plate according to claim 1, wherein an end portion of the body serves as a power connection end, and the power connection end is provided with a necked receiving power connection port.

3. The electrode plate according to claim 2, wherein the length of the conductive layer is less than that of the semiconductor layer, and the conductive layer extends to the power connection end.

4. The electrode plate according to claim 3, wherein the area of one end portion of the conductive layer located at the power connection end is less than the area of the other end portion of the conductive layer.

5. The electrode plate according to claim 1, wherein the end portion of the body is provided with a process circular hole, and a spacing between the process circular hole and the end portion of the body is 2-5 mm.

6. The electrode plate according to claim 1, wherein the fixed mounting positions and the avoiding ports are set as slotted openings and/or semicircular openings, respectively.

7. The electrode plate according to claim 1, wherein the spacings between an edge of the conductive layer, the fixed mounting positions and the avoiding ports are equal.

8. The electrode plate according to claim 1, wherein the conductive layer is made of a conductive material and an additive, the conductive material comprising graphite, graphene or conductive printing ink, and the additive comprising organosilicon; the semiconductor layer is made of a high polymer material and a heat conduction material, the high polymer material comprising polyvinyl chloride, polyethylene, polypropylene, ABS plastic or polytetrafluoroethylene, and the heat conduction material comprising one or more combinations of aluminium oxide, silicon dioxide, metal powder, silicon nitride, aluminium nitride, zinc oxide, calcium oxide, graphite and graphene; and the insulation layer is made of one or more combinations of polypropylene, ABS plastic, polyamide, polyoxymethylene, polytetrafluoroethylene or polycarbonate.

9. The electrode plate according to claim 8, wherein the thickness of the insulation layer is 0.1-1.0 mm, the thickness of the semiconductor layer is 0.05-0.5 mm, and the thickness of the conductive layer is 0.005-0.03 mm.

10. The electrode plate according to claim 1, wherein adhesive layers are provided between the semiconductor layer, and the insulation layer and the conductive layer.

11. A purification and dust removal device, comprising a frame body, wherein a plurality of alternately superimposed ground electrode plates and high-voltage electrode plates are provided inside the frame body, and the ground electrode plates and the high-voltage electrode plates employ the electrode plate according to claim 1.

12. The purification and dust removal device according to claim 11, wherein the ground electrode plates and the high-voltage electrode plates are connected to fixed separators, respectively, and the fixed separators are insulation adhesives and/or rigid insulating parts.

13. The purification and dust removal device according to claim 12, wherein an insulation adhesive layer is provided between the ends of the frame body and the electrode plate, and the insulation adhesive layer covers the process circular hole at the end portion of the electrode plate.

14. The purification and dust removal device according to claim 13, wherein the ground electrode plates and the high-voltage electrode plates are provided in a 180° staggered manner, gaps are present between end portions of the ground electrode plates and the high-voltage electrode plates, and the insulation adhesive layer does not cover or cover the gaps.

15. The purification and dust removal device according to claim 11, wherein the thickness of the semiconductor layer of the dust collection layer electrode plate is less than that of the non-dust collection layer electrode plate.

16. The purification and dust removal device according to claim 11, wherein further comprising a high-voltage power supply, wherein the high-voltage power supply is located inside or outside the frame body.
